(19) United States
(12) Patent Application Publication
(10) Pub. No.: US 2020/0239103 A1
(43) Pub. Date: Jul. 30, 2020

(54) Powered, programmable machine and method for transforming a bicycle to fit particular riders and/or riding conditions

(71) Applicant: Kenneth Robert Abbey, Lake Oswego, OR (US)

(72) Inventor: Kenneth Robert Abbey, Lake Oswego, OR (US)

(21) Appl. No.: 16/731,962

(22) Filed: Dec. 31, 2019

Related U.S. Application Data
(60) Provisional application No. 62/797,134, filed on Jan. 25, 2019.

(51) Int. Cl. B62M 3/04; B62M 1/36; B62K 21/16; B62J 1/08; B62J 45/20; B62J 50/22; B62K 21/22; B62J 43/30; B62J 43/20; B62J 45/412; B62J 45/415; H04W 4/48

(52) U.S. Cl. CPC B62M 3/04; B62M 1/36; B62K 21/16; B62J 1/08; B62J 45/20; B62J 50/22; B62J 2001/085; B62J 43/30; B62J 43/20; B62J 45/412; B62J 45/415; H04W 4/48; B62K 21/22

(57) ABSTRACT

The present invention provides a means for powered, programmable transformation of a bicycle to fit a given cyclist for a given condition while riding. It comprises a computer/app and actuators to perform all adjustments while riding, that is programmable to recall fit information and/or to follow a fit algorithm that will transform a bicycle to match a particular rider's best fit for a particular condition such as climbing, descending, sprinting, etc. It also may adjust fit in response to “on-the-fly” rider commands, sensor inputs, and/or data from other devices.

### RELATED APPLICATIONS

The present application is a utility patent application claiming the benefit of Provisional Patent Application No. 62/797,134, filed Jan. 25, 2019. The present application is based upon and claims priority from Application No. 62/797,134, the disclosure of which is hereby expressly incorporated herein by reference in its entirety.

### STATEMENT REGARDING FEDERALLY SPONSORED RESEARCH OR DEVELOPMENT

Not Applicable.

### BACKGROUND OF THE INVENTION

### Field of the Invention

The present invention relates to the fitting of bicycles for particular riders and particular conditions. It provides a computer-controlled machine and method for transforming the fit of the bicycle to suit a particular rider and/or condition and thereby optimize the rider's power output, speed, efficiency, and comfort. It also will provide for “on-the-fly” changes in position at the rider's discretion using a computer control device for rider-selected adjustment or by use of preprogrammed positions for particular conditions. The system will also permit preprogrammed fits for multiple riders that can be selected “on-the-fly” to allow riders to switch bikes with other riders and obtain a favorable riding position on the borrowed bicycle.

### Description of the Related Art

J. K. Starley's Rover “safety bicycle” was developed in 1885 as a successor to the “Penny Farthing” designs. Most modern bicycles are derivative of this design including road, mountain, cyclocross, commuter, and touring bicycles. For all of these types, rider comfort and performance depend in large part upon the quality of “fit” between the rider and the bicycle. Poorly fitting bicycles limit the ability of a rider to efficiently transfer power to the drivetrain, are uncomfortable, and increase the risk of injury due to accident or due to stress or repetitive motion.

The fit of a bicycle depends upon the interaction of the rider and bicycle at three primary points of contact: saddle, handlebars, and pedals. For casual riders, the fit typically depends on the diligence of the bicycle salesperson and trial and error by the rider. For serious cyclists, bicycle fit is a combination of precise measurement and calculation as well as the art and experience of a bike fit expert who may spend hours with the cyclist perfecting the fit of their bicycle. The final fit for serious cyclists and racers is measured at the millimeter scale.

Professional racers are generally capable of sensing improper fits of a single parameter of only 1 or 2 mm. It is not uncommon in the modern era to see Tour de France racers making minute fit adjustments while riding using tools provided by their team cars. Pros consider the inconvenience and inherent risk of such maneuvers worthwhile to obtain the fit they require to perform at their best. So important is this issue for serious cyclists that an entire niche industry has sprung up to perfect bicycle fit that includes purpose-built software, CAD-CAM, special fitting jigs, and consultant companies devoted solely to this task. All of these methods of fitting a bicycle are aimed at finding a single, fixed, best fit for a particular rider to a particular bicycle for all of its intended purposes. Once the fit is established, cyclists and bicycle mechanics use precise measurements to maintain the precise fit following parts replacement and maintenance teardowns.

Although modern bicycle fit technique and technology has become very sophisticated, it retains a number of significant limitations inherent to bicycle design: 1) it requires labor-intensive work to establish and maintain to optimum fit, 2) it does not permit a rider to safely or conveniently adjust fit while riding, 3) it ultimately achieves a compromise position that does not adjust for different riding conditions, for example climbing versus descending, 4) it does not permit rapid or convenient adjustment between different riders, for example when a racer needs to switch to a teammate's bicycle mid-race, 5) it cannot automatically adjust fit to different riders or conditions, 6) it cannot calculate a basic fit using computer algorithms, and automatically adjust the bicycle. All of these deficiencies are addressed by the present invention.

Most modern bicycles use simple, fixed adjustment devices to adjust each of the following parameters: handlebar height, angle relative to direction of travel, angle relative to the frame; saddle height, fore/aft tilt, angle relative to direction of travel, fore/aft position relative to the steerer post, and side to side tilt. Some bicycles permit adjustment of crank length. For all of these adjustments, most modern bicycles allow the adjustment of a given element by loosening a set screw (usually an Allen head bolt on quality bicycles), manual adjustment of the position, and then retightening of the set screw. Measurement is generally done manually using rulers, tape measures, levels, and similar instruments.

Prior art does exist for some adjustment while riding, mostly relating to seat height. The most commonly used device is for mountain bikes and is known as a “dropper post.” A number of companies offer these mechanical devices that function in principal like the height adjustment on a typical office chair. Generally, they have a lever mounted either under the seat or on the handlebars that releases the post so that the rider can push it down into the frame using the rider's weight. Return is via a spring that permits the post to rise when the release lever is actuated with the rider off of the seat. The purpose of dropper posts is to allow riders to lower the seat out of the way when it would interfere with the rider's position. Most often, it is used during steep descents to allow the rider to drop their torso over and near to the rear wheel thereby transferring weight toward the rear of the bike for better control. When the rider wishes to pedal efficiently (on level ground or while climbing), the post is released back into the position for sitting.

In U.S. Pat. No. 8,668,262 B2, Kim discloses a manually activated release to permit easy adjustment of saddle fore/aft tilt. In U.S. Pat. No. 8,544,947 B2, Sloan discloses a manual adjustment mechanism for stationary bicycles that permits rapid adjustment between users of seat height, tilt, and distance to handlebars.

Some prior art exists for power adjustment of bicycle fit, specifically for seat height. In U.S. Pat. No. 6,050,585, Kuljeet discloses a powered seat height adjuster. It consists of a battery power source, up/down switch, and gearing (specifically bevel gears) to allow an electric motor to raise and lower a seat post with a similar object as dropper posts.

Prior art exists regarding various algorithms and devices to assist in bike fitting:
In US 2011/0077125, Kenyon discloses a device for adjustment of a stationary fitting bike while the rider pedals. It consists of a stationary bike with electronic adjustment of most position parameters and a system for measuring power output and cadence (pedal rpm). The rider being fitted can pedal the stationary bike, and position adjustments can be made electronically without requiring the cyclist to dismount or stop pedaling.
In US 2008/0058170, Giannascoli et al. disclose another semi-automated method of bicycle fitting using a stationary bicycle and a computer algorithm. In this design, the inventors include a stationary bicycle that is manually adjustable in various parameters. Electronic measurements of those parameters are communicated to a computer along with performance measurements to “record stationary bicycle adjusted positions” and “suggest bicycle frames in accordance with adjusted positions.”
In US 2007/0142177, Simms and Ogden disclose a process for computer-assisted fitting of a cyclist using a stationary bicycle or bicycle on a trainer (a mechanism that holds a standard bicycle and absorbs power from its drivetrain to permit exercise indoors). Their process involves placing the cyclist on a stationary bicycle, attaching markers to the rider that can be sensed by a tracker, measuring performance parameters while tracking the position of the cyclist on the bicycle, and then creating a report that can be used to establish the optimum position of the cyclist. The report contains measurements that can be used to adjust a bicycle. The inventors also disclose an “advanced embodiment” that would electronically communicate the measurements to a bicycle simulator that could then automatically adjust to fit the cyclist.
In US 2013/0138302, Hara and Kitamura disclose a seat height adjustment system consisting of an up/down switch, electronic adjuster, and a display that indicates the height of the seat.

### SUMMARY OF THE INVENTION

The present invention (“PowerFit”) provides a machine and method for transforming the fit of a bicycle “on-the-fly” using a central computer control device (“Control”) or another device such as a smartphone or cycling computer containing software or an app (“Control App”) permitting the device to function as a control device (“Control Device”). For simplicity, the Control or Control Device is referred to herein generically as the “Controller.” PowerFit consists of a Controller as well as separate actuator/sensor systems (“Actuators”) for each of the points of contact between the cyclist and the bicycle: saddle, handlebars, and pedals. It further provides a method for programming the Controller so that optimized fit settings (“Program Settings”) can be selected by the rider while riding to suit different riders and/or different conditions. Examples of such Program Settings might include, for example, “Ken's Fit” or “Dan's Fit”, “Climb,” “Descend,” “Sprint,” etc.

The Controller provides a means for communicating with the rider and for receiving commands from the rider. It also includes a means for communicating with the actuators so that the Controller has data about their current positions and is able to transmit commands to change their positions. The Controller has means to communicate data to the rider via display or audio. It further has means to receive commands from the rider via appropriate controls such as voice, touchscreen, buttons, knobs, sliders, or other such controls. It may also adjust settings based upon data about conditions such as rider weight, bicycle speed, angle of gradient, or other data inputs. The Controller has memory to retain information about current settings as well as previously provided Program Settings.

The Actuators communicate with the Controller via wired or wireless communication. Each Actuator is capable of sensing the position or one element of position for each point of contact (for example: seat tilt). The Actuator communicates the current position to the Controller and then corrects the position to coincide with the position called for by the Controller based upon the rider-chosen Program Setting or rider command. Actuators may be powered by any appropriate power source but in most cases by electricity. Electricity or other stored power may be stored by each Actuator, at each point of rider contact, or centrally. Power may also be supplied by wheel or pedal motion, solar power, or other suitable power source.

### BRIEF DESCRIPTION OF THE DRAWINGS

FIG. 1 is a side view of a representative bicycle showing an exemplary arrangement of the elements of the invention including the Controller and four Actuators located at the saddle, the handlebars, and one each on the left and right pedal cranks.

FIG. 2 is a representative view of the Controller showing one embodiment of an exemplary display for the invention.

FIG. 3 is a diagram showing the interaction of the Controller with the Actuators.

FIG. 4 is a flowchart of the method used to control and program the fit between the cyclist and the bicycle using the PowerFit invention.

### DETAILED DESCRIPTION OF THE INVENTION

Selected embodiments will now be explained with reference to the drawings. It will be apparent to those skilled in the art from this disclosure that the following descriptions of the embodiments are provided for illustration only and not for the purpose of limiting the invention.

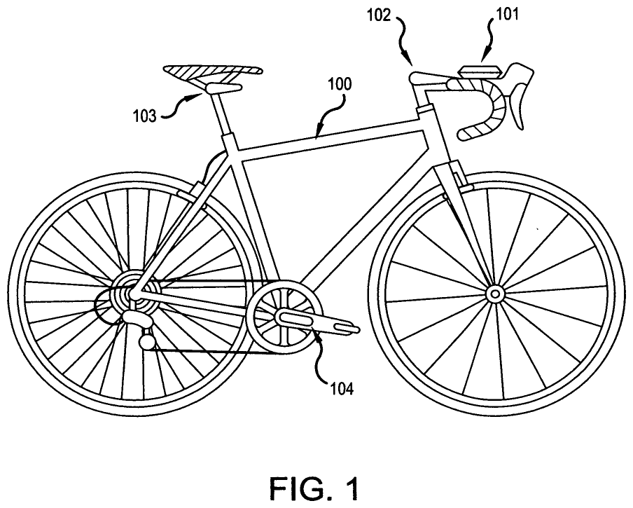

FIG. 1 demonstrates the general arrangement of the invention elements in one (preferred) embodiment as mounted on a representative road bicycle. The PowerFit elements are mounted on a bicycle 100 such that the Controller 101 is mounted on the right top bar of the handlebars. An Actuator to control the position of the handlebars (“Handlebar Actuator” 102) is shown mounted to the top of the steerer tube. An Actuator to control the position of the saddle (“Saddle Actuator” 103) is shown mounted under the saddle and attached to the seat post. An Actuator to control the length of the crank arm (“Crank Actuator” 104) is shown mounted on the right crank arm. Another Crank Actuator (not shown) is mounted on the left crank arm. The elements of the invention have the following functions:
The Controller 101 consists of a dedicated computer device or as an App/software running on another device (e.g. a smartphone or cycling computer). It interfaces with the cyclist to communicate information about the bicycle fit via visual display, audio output, or via wireless communication with another display/headset/device. It further has means to receive commands from the rider via appropriate controls such as voice, touchscreen, buttons, knobs, sliders, or other such controls. It also includes a means for communicating with the actuators so that the Controller 101 has data about their current positions and is able to transmit commands to change their positions. Such communication may be via physical (e.g. wire or optical cable) or wireless (e.g. Bluetooth) means. The Controller 101 also has computer memory to retain programming input by the cyclist, position information provided by the Actuators, or other data (e.g. speed, power output, altitude, and/or gradient). It may include other capabilities such as the ability to provide an automatic fit based upon a fit algorithm and inputs of measurements/preferences of the cyclist.
The Actuators 102, 103, 104 each control one or more fit parameters and interface with the Controller. Each Actuator consists of a device that can interface with the Controller via physical or wireless means. Each contains a processor that can sense one or more fit parameters and communicate the position of each parameter to the Controller. Each also can receive commands from the Controller that instruct the Actuator to adjust each parameter in accordance with the commands of the Controller. Each Actuator has a source of power for its processor and for contained servos or other systems to drive the adjustments. In this preferred embodiment, a central battery contained in the Controller provides power for the Controller 101 and each Actuator 102, 103, 104 via electrical cables. The same cables are used to communicate between the Controller 101 and each Actuator 102, 103, 104.
The Handlebar Actuator 102 senses and controls the position of the handlebars and interfaces with the Controller 101. In this exemplary (preferred) embodiment, the Handlebar Actuator senses and controls the following parameters: the height of the handlebar stem relative to the steerer tube, the angle of the handlebars in the handlebar clamp, and the length of the handlebar stem extension.
The Saddle Actuator 103 senses and controls the position of the saddle and interfaces with the Controller 101. In this exemplary (preferred) embodiment, the Saddle Actuator senses and controls the following parameters: saddle up/down, saddle slide front/back, saddle nose up/down, saddle tilt left/right.
The Crank Actuator 104 senses and controls the position of right pedal crank arm and interfaces with the Controller 101. In this exemplary (preferred) embodiment, the Crank Actuator 104 senses and controls the length of the right pedal crank arm. An identical Crank Actuator (not shown) senses and controls the length of the left pedal crank arm.

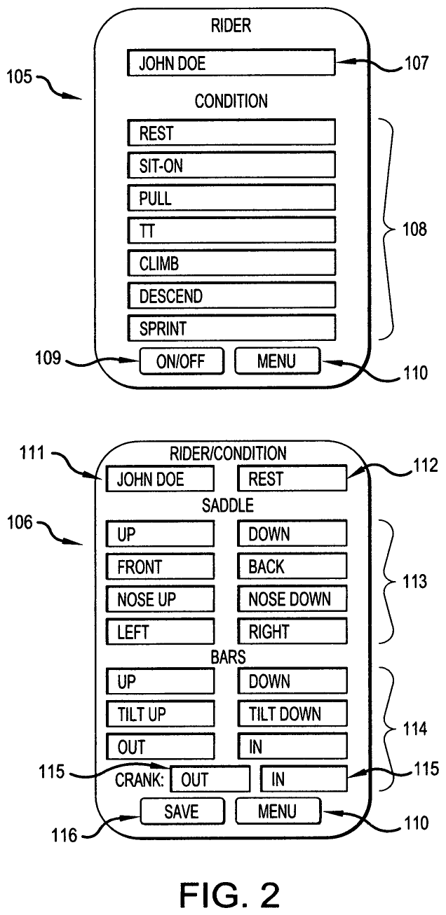

FIG. 2 shows an exemplary Controller 101 displaying two different menus. The Home Menu 105 is shown at the top of FIG. 2. The Programming Menu 106 is shown at the bottom. The exemplary Controller 101 demonstrates the use of a touchscreen similar to those present on smartphones. Other types of controls are envisioned including voice and physical buttons, knobs, sliders, and the like. For some applications, touchscreens may prove impractical when cyclists wear gloves or ride in inclement weather.

The Home Menu 105 shows an exemplary arrangement of controls that can be used to select a fit program for a particular rider in particular conditions. Under the title “Rider,” control 107 can be “swiped” to find the programs for the current cyclist. Under the title “Condition,” the appropriate button from the condition buttons 108 can be selected. The Controller 101 can be turned on or off using button 109. The menus can be cycled from one to the next using the Menu button 110.

The Programming Menu 106 shows an exemplary arrangement of controls that can be used to create a fit program for a particular rider for a particular condition. Under the title “Rider/Condition,” control 111 can be “swiped” to select a cyclist. Control 112 can be “swiped” to select a condition. Once these selections have been made, the fit of the bicycle can be adjusted. Under the title “Saddle,” the buttons 113 can be used to adjust the various fit parameters related to the position of the saddle. Under the title “Bars,” the buttons 114 can be used to adjust the various fit parameters related to the position of the handlebars. Next to the title “Crank,” the buttons 115 can be used to adjust the length of the crank arms. Once the fit has been adjusted as desired, the current fit can be saved as a program for the currently selected rider and condition by pressing the “Save” button 116.

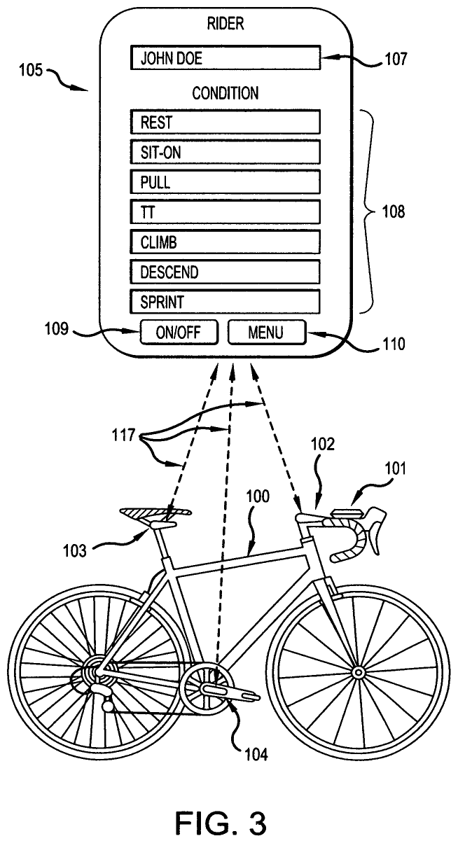

FIG. 3 shows an exemplary arrangement of the interaction between the Controller and the Actuators. In this example, the Controller 101 is open to the Home Menu 105. The rider “John Doe” has been selected via the control 107, and a condition (e.g. “Climb”) selected using the condition buttons 108. The Controller 101 compares the selected fit program in its memory against the current fit of the bicycle based upon the data reported to it from the various Actuators via a physical or wireless means of communication. It then communicates commands to the various Actuators via a physical or wireless means of communication to adjust the fit parameters to match the selected fit program (the communication between the Controller 101 and the Actuators 102,103,104 is represented by the dashed, double-ended arrows 117). The various Actuators then communicate back the new fit data to confirm completion of the adjustments.

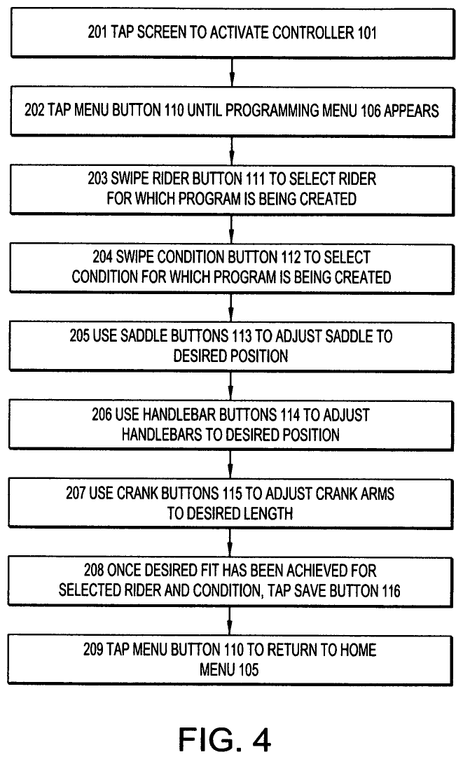

FIG. 4 shows a flowchart summarizing an exemplary method for programming the Controller. As the flowchart is self-explanatory, the method will not be repeated in this text.

### CLAIM LISTING

While this invention has been described by reference to particular embodiments, it should be understood that numerous changes could be made within the spirit and scope of the inventive concepts described. Accordingly, it is intended that the invention not be limited to the disclosed embodiment, but that it have the full scope permitted by the language of the following claims.

The invention claimed is:

1. An electronic control system for a bicycle, comprising:
a controller with a user interface transmitting a fit signal and receiving inputs;
at least one powered actuator receiving a command from the controller and adjusting at least one fit parameter in accordance with the command from the controller, the actuator sensing the fit parameter(s) and communicating the status to the controller.

2. The control system of claim 1, wherein the controller is programmable to adjust at least one fit parameter for a particular cyclist and/or particular condition in response to an input.

3. The control system of claim 2, wherein the controller includes a program to provide an automatic fit based upon a fit algorithm in response to an input.

4. The control system of claim 2, wherein the controller includes a program to adjust fit in response to inputs from one or more sensors and/or other devices.

5. The control system of claim 2, wherein the controller, actuator(s), and/or other devices communicate wirelessly.

6. The control system of claim 2, wherein the controller and actuator(s) adjust the fit parameter(s) of saddle height, saddle position front/back, saddle side-to-side tilt, and/or saddle angle nose up/down.

7. The control system of claim 6, wherein the controller and actuator(s) adjust the fit parameter(s) of handlebar stem height relative to the steerer tube, angle of handlebars in the handlebar clamp, and/or length of the handlebar stem extension.

8. The control system of claim 7, wherein the controller and actuator(s) adjust the fit parameters of the length of the right and left crank arms.

9. A powered actuator receiving inputs and providing outputs to a controller to adjust at least one fit parameter on a bicycle, comprising:
a base part attachable to a bicycle;
a movable part attached to a component of the bicycle;
a linkage interconnecting the base part to the movable part to enable the movable part and attached component to move relative to the base part;
a motor or other power source disposed on the actuator to power the motion of the movable part;
a power storage source incorporated into the actuator, separate from the actuator, and/or shared with other devices attached to the bicycle.

10. The powered actuator of claim 9, wherein the actuator includes a transmitter and receiver.

11. The powered actuator of claim 9, wherein the actuator is powered on by an input from the controller.

12. The powered actuator of claim 9, wherein the controller and actuator(s) adjust the fit parameters of saddle height, saddle position front/back, saddle side-to-side tilt, and/or saddle angle nose up/down.

13. The powered actuator of claim 12, wherein the controller and actuator(s) adjust the fit parameter(s) of handlebar stem height relative to the steerer tube, angle of handlebars in the handlebar clamp, and/or length of the handlebar stem extension.

14. The powered actuator of claim 13, wherein the controller and actuator(s) adjust the fit parameters of the length of the right and left crank arms.

15. An electronic control system for a bicycle, comprising:
a controller with a user interface transmitting a fit signal and receiving inputs;
at least one powered actuator receiving a command from the controller and adjusting at least one fit parameter in accordance with a command from the controller, the actuator sensing the fit parameter(s) and communicating the status to the controller;
software interfacing with the rider to permit programming of at least one fit parameter for a particular cyclist and/or particular condition.

16. The electronic control system of claim 15, wherein the software includes an algorithm to provide an automatic fit for a particular cyclist and/or particular condition.

17. The electronic control system of claim 15, wherein the software adjusts at least one fit parameter in response to inputs from (an)other device(s) measuring climatic, bicycle, rider parameters, and/or rider conditions.

18. The electronic control system of claim 15, wherein the software adjusts at least one fit parameter in response to measurements of bicycle speed, gear position, and/or surface gradient.

19. The electronic control system of claim 15, wherein the software adjusts at least one fit parameter in response to cyclist power output.

20. The electronic control system of claim 15, wherein the software adjusts at least one fit parameter in response to a signal from a remote device.
